(19) United States
(12) Patent Application Publication
(10) Pub. No.: US 2014/0020577 A1
(43) Pub. Date: Jan. 23, 2014

(54) LIQUID SUPPLY APPARATUS

(71) Applicant: KOMORI CORPORATION, Tokyo (JP)

(72) Inventors: Tasuku KONDO, Tsukuba-shi (JP); Isao KOMURO, Tsukuba-shi (JP); Kosuke MAEDA, Tsukuba-shi (JP)

(73) Assignee: KOMORI CORPORATION, Tokyo (JP)

(21) Appl. No.: 13/947,511

(22) Filed: Jul. 22, 2013

(30) Foreign Application Priority Data
Jul. 23, 2012 (JP) 2012-162480
Jul. 23, 2012 (JP) 2012-162481

(51) Int. Cl. B41F 15/42

(52) U.S. Cl. CPC B41F 15/42
USPC 101/120

(57) ABSTRACT

A rotary screen apparatus includes: a hollow cylinder having multiple holes formed therein and configured to come into contact, at its outer peripheral surface, with the surface of a sheet held on an impression cylinder; a rotary screen including a squeegee configured to extrude ink delivered to the inner peripheral surface of the hollow cylinder through the holes by coming into contact with the inner peripheral surface of the hollow cylinder; and a restricting plate, disposed on the downstream side of the squeegee in the moving direction thereof in relative movement of the hollow cylinder and the squeegee performed when the ink is extruded through the holes in the hollow cylinder, for restricting movement of the ink such that the ink is kept within a space present on a downstream side of the portion of the squeegee in contact with the hollow cylinder in the moving direction.

### TECHNICAL FIELD

The present invention relates to a liquid supply apparatus which supplies liquid from a plate onto the surface of a target with a squeegee, and is effective particularly when applied to a rotary screen apparatus which performs printing of ink or coating of varnish from a rotary screen onto the surface of a sheet or web with a squeegee.

### BACKGROUND ART

A rotary screen apparatus which performs printing of ink onto the surface of a sheet, for example, is capable extruding ink with a squeegee from inside through multiple holes formed in a rotary screen to perform screen printing of the ink onto a sheet held on the outer peripheral surface of an impression cylinder (see Patent Literature 1 listed below, for example).

### CITATION LIST

### Patent Literature

{Patent Literature 1}Japanese Patent No. 4508686

### SUMMARY OF INVENTION

### Technical Problem

In a conventional rotary screen apparatus as mentioned above, in the case of rotating the rotary screen and the like at high speeds to perform high speed screen printing, the ink delivered to the inside of the rotary screen intensively collides with the squeegee and splashes back and is stirred to a great extent. This causes inclusion of air inside the ink and increases the likelihood of bubbling of the ink. When the ink bubbles as described above, the ink extruded through the holes in the rotary screen is likely to be uneven, thereby possibly causing deterioration in printing quality.

This problem can occur as in the case described above to liquid supply apparatuses which extrude liquid through holes in a plate with a squeegee to supply the liquid onto the surface of a target, such as a rotary screen apparatus which performs screen printing of ink onto the surface of a sheet, as well as a rotary screen apparatus which performs screen printing of ink onto the surface of a web, a rotary screen apparatus which performs screen coating of varnish onto the surface of a sheet or web, and a lithographic screen apparatus which performs screen printing of ink and screen coating of varnish onto the surface of a sheet or web, for example.

In view of the above, an object of the present invention is to provide a liquid supply apparatus capable of evenly supplying liquid onto the surface of a target.

### Solution to Problem

A liquid supply apparatus according to the present invention for solving the aforementioned problem provides a liquid supply apparatus, including: a plate having a plurality of holes formed therein and configured to come into contact, at one surface, with a surface of a target; a squeegee configured to extrude liquid delivered to the other surface of the plate to the surface of the target through the holes by coming into contact with the other surface of the plate; and liquid movement restricting means, disposed on a downstream side of the squeegee in a moving direction thereof in relative movement of the plate and the squeegee performed when the liquid is extruded through the holes in the plate, for restricting movement of the liquid such that the liquid is kept within a space present on a downstream side of a portion of the squeegee in contact with the plate in the moving direction.

Moreover, a liquid supply apparatus according to the present invention provides the above-described liquid supply apparatus in which the liquid movement restricting means covers at least a part of the space.

Moreover, a liquid supply apparatus according to the present invention provides the above-described liquid supply apparatus in which the liquid movement restricting means extends in such a way as to be connected to the squeegee with no gap therebetween.

Moreover, a liquid supply apparatus according to the present invention provides the above-described liquid supply apparatus in which the liquid movement restricting means is disposed in such a way as not to contact the plate, thus leaving a gap therebetween.

Moreover, a liquid supply apparatus according to the present invention provides the above-described liquid supply apparatus in which the liquid movement restricting means includes: a first liquid movement restricting member, disposed on the downstream side of the squeegee in the moving direction thereof in the relative movement of the plate and the squeegee performed when the liquid is extruded through the holes in the plate, for restricting movement of the liquid toward a downstream side in the moving direction such that the liquid is kept within the space present on the downstream side of the portion of the squeegee in contact with the plate, in the moving direction; and second liquid movement restricting members, disposed respectively on both end sides of the first liquid movement restricting member in a horizontal direction perpendicular to the moving direction, for restricting movement of the liquid in the horizontal direction perpendicular to the moving direction such that the liquid is kept within the space.

Moreover, a liquid supply apparatus according to the present invention provides the above-described liquid supply apparatus in which the first liquid movement restricting member covers at least a part of a downstream side of the space in the moving direction, and the second liquid movement restricting members cover at least a part of both end sides of the space in the horizontal direction.

Moreover, a liquid supply apparatus according to the present invention provides the above-described liquid supply apparatus in which the second liquid movement restricting members are formed by bending both end sides, in the horizontal direction perpendicular to the moving direction, of the first liquid movement restricting member toward the other surface of the plate.

Moreover, a liquid supply apparatus according to the present invention provides the above-described liquid supply apparatus in which the second liquid movement restricting members are disposed in such a way as not to contact the plate, thus leaving a gap therebetween.

### Advantageous Effect of Invention

According to the liquid supply apparatus of the present invention, the liquid movement restricting means restricts movement of liquid such that the liquid is kept within the space present on the downstream side of the portion of the squeegee in contact with the plate in the moving direction. Thus, it is possible to significantly reduce inclusion of air inside the liquid and bubbling of the liquid. Hence, the liquid extruded through the holes in the plate is less likely to be uneven and can therefore be supplied evenly onto the surface of the target.

### BRIEF DESCRIPTION OF DRAWINGS

FIG. 1 shows a schematic configuration diagram of a main part of a first embodiment in which a liquid supply apparatus according to the present invention is applied to a rotary screen apparatus;

FIG. 2 shows a view seen from the direction of arrow II in FIG. 1;

FIG. 3 shows a schematic configuration diagram of a main part of a second embodiment in which the liquid supply apparatus according to the present invention is applied to a rotary screen apparatus; and

FIG. 4 shows a view seen in the direction or arrow IV in FIG. 3.

### DESCRIPTION OF EMBODIMENTS

Embodiments of a liquid supply apparatus according to the present invention will be described with reference to the drawings. Note that the liquid supply apparatus according to the present invention is not limited only to the embodiments to be described below based on the drawings.

### First Embodiment

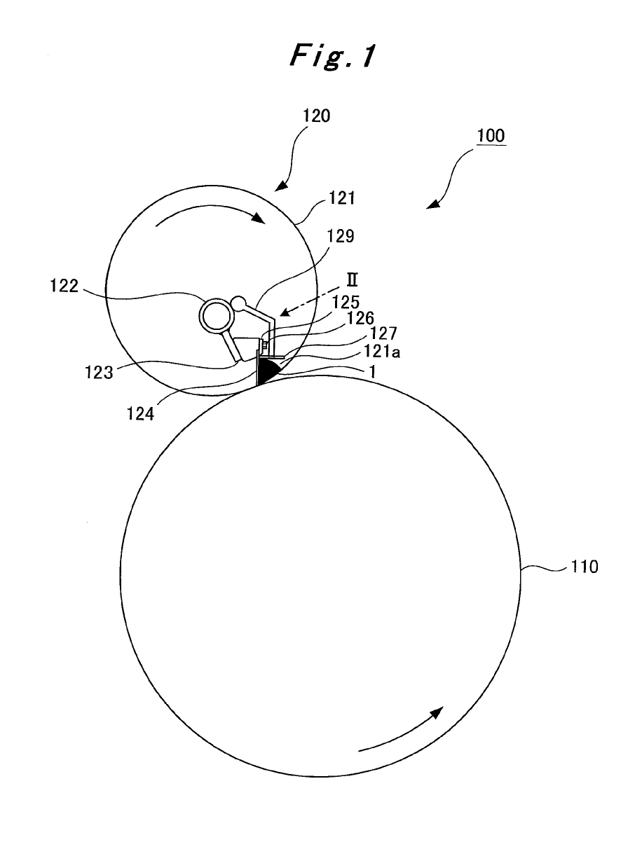

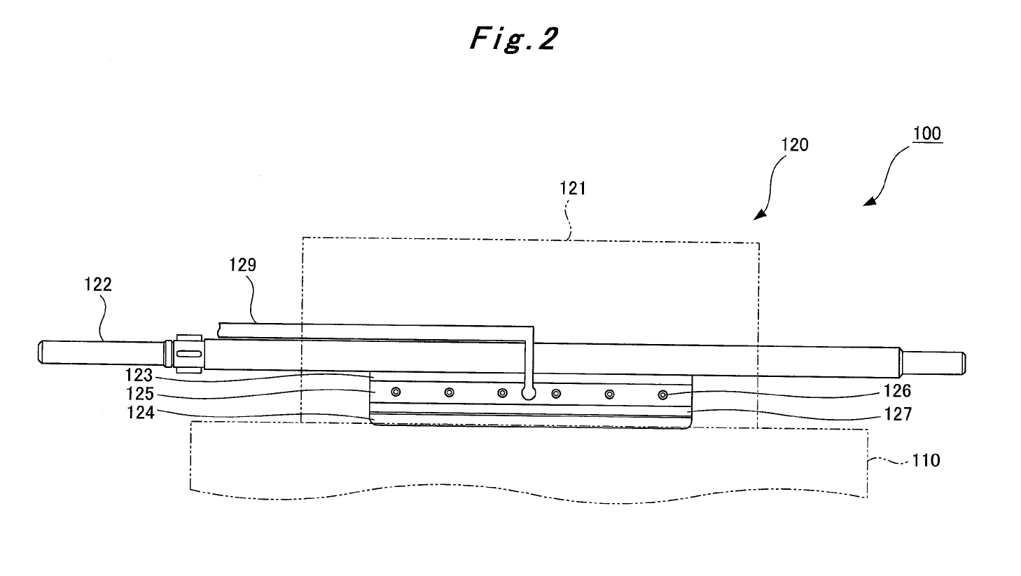

A first embodiment in which the liquid supply apparatus according to the present invention is applied to a rotary screen apparatus will be described based on FIGS. 1 and 2.

As shown in FIG. 1, a rotary screen 120 which is rotatably supported faces and contacts an impression cylinder 110 which is rotatably supported and configured to detachably hold a sheet, or a target, on the outer peripheral surface thereof. The rotary screen 120 has the following structure.

As shown in FIGS. 1 and 2, there is a hollow cylinder 121 which is a rotatably supported, cylindrical thin screen (plate) having multiple small holes formed therein in a given image pattern. Inside this hollow cylinder 121, a support shaft 122 is disposed with its longitudinal direction set along the axial direction of the hollow cylinder 121. A bracket 123 is provided on the support shaft 122 along the longitudinal direction of the support shaft 122. A plate-shaped squeegee 124 with its longitudinal direction set along the axial direction of the hollow cylinder 121 has its base end side fixed to and supported on the bracket 123 by bolts 126 with a fixing plate 125 therebetween. The position of the squeegee 124 is set such that its tip end side contacts the inner peripheral surface (the other surface) of the hollow cylinder 121.

A restricting plate 127 is provided on the surface of the squeegee 124 on the upstream side in the rotating direction of the hollow cylinder 121, i.e., the surface of the squeegee 124 on the downstream side in the moving direction thereof in relative movement of the squeegee 124 and the hollow cylinder 121 (the right side in FIG. 1), at a position near the base end of the squeegee 124 (near the upper end in FIG. 2). The restricting plate 127 is liquid movement restricting means covering a space 121a present on an upstream side of the portion of the squeegee 124 in contact with the hollow cylinder 121 in the rotating direction, i.e. a downstream side in the moving direction of the squeegee 124 in the relative movement. The base end side of the restricting plate 127 (the left side in FIG. 1) is attached to the squeegee 124 with no gap therebetween, while the tip end side (the right side in FIG. 1) extends toward the inner peripheral surface of the hollow cylinder 121 to such an extent as not to contact the inner peripheral surface of the hollow cylinder 121, thereby leaving a gap therebetween. In this way, only some part of an opening of the space 121a formed by the squeegee 124 and the hollow cylinder 121 is left open, while the most part of the opening is covered.

The tip end side of an ink delivering pipe 129 for delivering ink 1, which is liquid, is connected to a connecting hole which is formed in a middle portion of the restricting plate 127 in the longitudinal direction, penetrating from one surface side to the other surface side thereof. The base end side of the ink delivering pipe 129 is connected to an unillustrated ink delivering device installed outside the hollow cylinder 121. By actuating this ink delivering device, the ink 1 can be delivered through the ink delivering pipe 129 into the space 121a on the inner peripheral surface (the other surface) of the hollow cylinder 121.

Note that in this embodiment, the ink delivering pipe 129, the ink delivering device, and the like constitute liquid supplying means.

In a rotary screen apparatus 100 according to this embodiment as described above, upon actuation of the ink delivering device to deliver the ink 1 through the ink delivering pipe 129 into the space 121a of the hollow cylinder 121, together with rotation of the impression cylinder 110 and the hollow cylinder 121 of the rotary screen 120, the squeegee 124 extrudes the ink 1, delivered in the space 121 of the hollow cylinder 121, to the outer peripheral surface (one surface) of the hollow cylinder 121 through the holes therein. Thus, the ink 1 can be screen-printed onto the surface of a sheet held on the impression cylinder 110 and brought into contact with the outer peripheral surface (one surface) of the hollow cylinder 121.

Here, in the case where the impression cylinder 110 and the hollow cylinder 121 of the rotary screen 120 are rotated at high speeds to perform high speed screen printing, the restricting plate 127 restricts movement of the ink 1 toward the upstream side in the rotating direction of the hollow cylinder 121, i.e., the downstream side in the moving direction of the squeegee 124 in the relative movement, so as to keep the ink 1 within the space 121a of the hollow cylinder 121. This makes it possible to prevent the ink 1 from being stirred to a great extent while intensively colliding with the squeegee 124 and splashing back. Accordingly, it is possible to significantly reduce inclusion of air inside the ink 1 and bubbling of the ink 1.

Thus, with the rotary screen apparatus 100 according to this embodiment, the ink 1 extruded through the holes in the hollow cylinder 121 is less likely to be uneven, allowing even printing of the ink onto the surface of a sheet. Accordingly, deterioration in printing quality can be prevented.

Moreover, because the base end side of the restricting plate 127 extends in such a way as to be connected to the squeegee 124 with no gap therebetween, the ink 1 does not leak from between the squeegee 124 and the base end side of the restricting plate 127, thereby making it possible to securely keep the ink 1 within the space 121a.

Furthermore, because the tip end side of the restricting plate 127 is set in such a way as not to contact the inner peripheral surface of the hollow cylinder 121, thus leaving a gap therebetween, it is possible to prevent the hollow cylinder 121 from being damaged when screen printing is performed or when the rotary screen 120 is moved relative to the impression cylinder 110 (cylinder disengagement, cylinder engagement).

### Second Embodiment

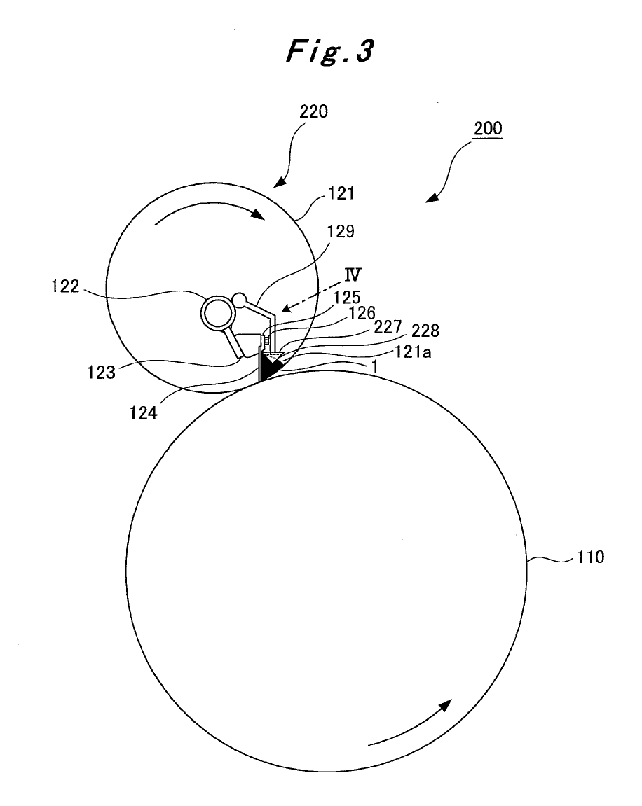

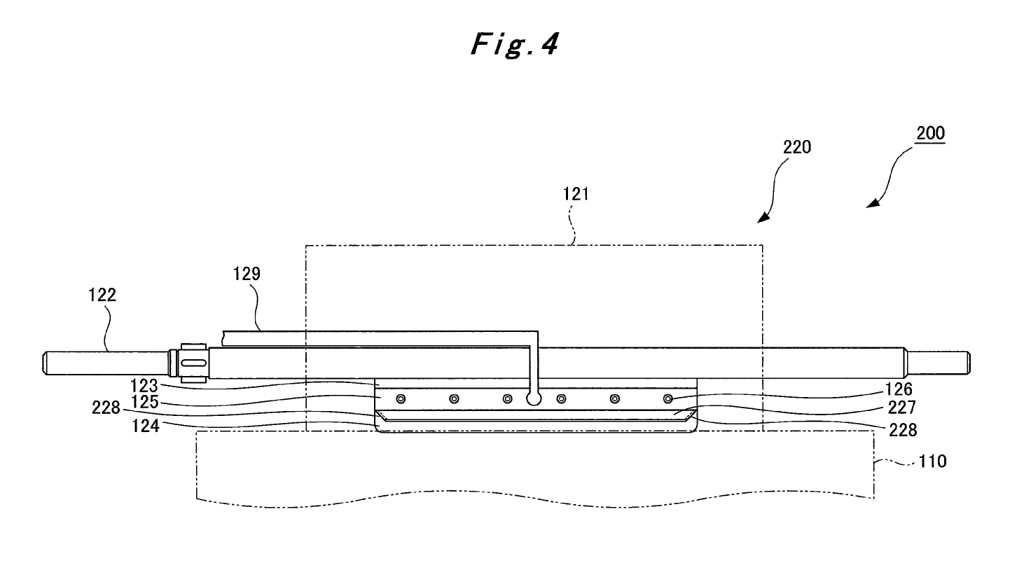

A second embodiment in which the liquid supply apparatus according to the present invention is applied to a rotary screen apparatus will be described based on FIGS. 3 and 4. Note that for the same components as those in the foregoing embodiment, the same reference signs as the signs used in the description of the foregoing embodiment are used, and description thereof overlapping the description in the foregoing embodiment is omitted.

As shown in FIG. 3, a rotary screen 220 which is rotatably supported faces and contacts the impression cylinder 110. The rotary screen 220 has the following structure.

As shown in FIGS. 3 and 4, the support shaft 122 is disposed inside the hollow cylinder 121. The bracket 123 is provided on the support shaft 122. The base end side of the squeegee 124 is fixed to and supported on the bracket 123 by bolts 126 with the fixing plate 125 therebetween.

A restricting plate 227 is provided on the surface of the squeegee 124 on the upstream side in the rotating direction of the hollow cylinder 121, i.e., the surface of the squeegee 124 on the downstream side in the moving direction thereof in relative movement of the squeegee 124 and the hollow cylinder 121 (the right side in FIG. 3), at a position near the base end of the squeegee 124 (near the upper end in FIG. 3). The restricting plate 227 is a first liquid movement restricting member covering the space 121a present on the upstream side of the portion of the squeegee 124 in contact with the hollow cylinder 121 in the rotating direction, i.e. the downstream side in the moving direction of the squeegee 124 in the relative movement. The base end side of the restricting plate 227 (the left side in FIG. 3) is attached to the squeegee 124 with no gap therebetween, while the tip end side (the right side in FIG. 3) extends toward the inner peripheral surface of the hollow cylinder 121 to such an extent as not to contact the inner peripheral surface of the hollow cylinder 121, thereby leaving a gap therebetween. In this way, only some part of an opening of the space 121a formed by the squeegee 124 and the hollow cylinder 121 is left open, while the most part of the opening is covered.

A pair of wall portions 228 are provided respectively on both end sides of the restricting plate 227 in the longitudinal direction, i.e. both end sides in a horizontal direction perpendicular to the moving direction (the left-right direction in FIG. 4). The wall portions 228 are second liquid movement restricting members for covering the space 121a and extend toward the inner peripheral surface of the hollow cylinder 121 to such an extent as not to contact the inner peripheral surface of the hollow cylinder 121, thereby leaving a gap therebetween. In this way, apart of each of both end sides of the space 121a in the horizontal direction perpendicular to the moving direction is left open, while the remaining part is closed. The wall portions 228 are formed by bending the corners of tip end portions (lower portions in FIG. 4) of both end sides, in the longitudinal direction (the left-right direction in FIG. 4), of the restricting plate 227 toward a center area of the inner peripheral surface of the hollow cylinder 121 in the axial direction.

The tip end side of the ink delivering pipe 129 is connected to a connecting hole which is formed in a middle portion of the restricting plate 227 in the longitudinal direction, penetrating from one surface side to the other surface side thereof.

Note that in this embodiment, the restricting plate 227, the wall portions 228, and the like constitute liquid movement restricting means, and the ink delivering pipe 129, the ink delivering device, and the like constitute liquid supplying means.

In a rotary screen apparatus 200 according to this embodiment as described above, the ink 1 can be screen-printed onto the surface of a sheet by performing actuation as in the foregoing embodiment.

Here, in the case where the impression cylinder 110 and the hollow cylinder 121 of the rotary screen 220 are rotated at high speeds to perform high speed screen printing, the restricting plate 227 restricts movement of the ink 1 toward the upstream side in the rotating direction of the hollow cylinder 121, i.e., the downstream side in the moving direction of the squeegee 124 in the relative movement, so as to keep the ink 1 within the space 121a of the hollow cylinder 121. This makes it possible to prevent the ink 1 from being stirred to a great extent while intensively colliding with the squeegee 124 and splashing back, as in the foregoing embodiment. Accordingly, it is possible to significantly reduce inclusion of air inside the ink 1 and bubbling of the ink 1.

Moreover, the wall portions 228 restrict movement of the ink 1 toward both ends of the hollow cylinder 121 in the axial direction (the horizontal direction perpendicular to the moving direction), so as to keep the ink 1 within the space 121a of the hollow cylinder 121. Thus, the ink 1 can be guided (returned) toward a center area of the hollow cylinder 121 in the axial direction, thus preventing the ink 1 from spreading outward and leaking beyond both ends of the squeegee 124 in the longitudinal direction from the inside of the space 121a. Accordingly, the ink 1 can be securely extruded through the holes in the hollow cylinder 121 with the squeegee 124.

Thus, with the rotary screen apparatus 200 according to this embodiment, it is possible to evenly print the ink 1 on the surface of a sheet and thus prevent deterioration in printing quality as a matter of course, as in the foregoing embodiment. In addition to this, it is possible to effectively utilize the ink 1 without wastefully using the ink 1, and also to prevent the ink from contaminating components such as end rings located on both end sides of the hollow cylinder 121 and thus make maintenance such as cleaning easier.

Moreover, because not only the tip end side of the restricting plate 227 but also the wall portions 228 are set in such a way as not to contact the inner peripheral surface of the hollow cylinder 121, thus leaving a gap therebetween, it is possible to prevent the hollow cylinder 121 from being damaged when screen printing is performed or when the rotary screen 120 is moved relative to the impression cylinder 110 (cylinder disengagement, cylinder engagement), as in the foregoing embodiment.

Moreover, because the wall portions 228 are formed by bending both end sides, in the longitudinal direction, of the restricting plate 227 toward the inner peripheral surface of the hollow cylinder 121, any joining process such as welding does not need to be performed, and only a plastic working such as bending is required. Accordingly, the wall portions 228 can be provided in a simple manner at a low cost.

### Other Embodiments

In the foregoing first and second embodiments, the ink delivering device is actuated to deliver the ink 1 through the ink delivering pipe 129 into the space 121a on the inner peripheral surface (the other surface) of the hollow cylinder 121. However, as another embodiment, it is possible to omit the ink delivering pipe 129, the ink delivering device, and the like, and instead to allow the operator to supply the ink 1 into the space 121a between the squeegee 124 and the restricting plate 127, 227 by using a ladle or the like in advance before starting the printing operation, for example.

Moreover, in the foregoing first and second embodiments, the restricting plates 127 and 227 are attached and fixed to and supported on the squeegee 124. However, as another embodiment, it is possible to dispose another support shaft inside the hollow cylinder 121 and fix and support the restricting plate 127, 227 to and on this support shaft, for example.

In this case, it is highly preferable to set the base end side of the restricting plate 127, 227 such that the base end side is connected to the squeegee 124 with no gap therebetween so as to be able to securely keep the ink 1 within the space 121a, thus allowing no leakage of the ink 1 from between the squeegee 124 and the base end side of the restricting plate 127, 227, and also to set the tip end side of the restricting plate 127, 227 and the wall portions 228 such that they do not contact the inner peripheral surface of the hollow cylinder 121, thus leaving a gap therebetween, so as to be able to prevent the hollow cylinder 121 from being damaged when screen printing is performed or when the rotary screen 120, 220 is moved relative to the impression cylinder 110 (cylinder disengagement, cylinder engagement).

Moreover, in the foregoing second embodiment, the wall portions 228 are formed by bending the corners of the tip end portions of both end sides, in the longitudinal direction, of the restricting plate 227 toward the center area of the hollow cylinder 121 in the axial direction. However, as another embodiment, it is possible to provide second liquid movement restricting members by bending both end sides, in the longitudinal direction, of the restricting plate 227 such that both end sides face each other, or by joining the second liquid moving restricting members to both end sides, in the longitudinal direction, of the restricting plate 227 by welding or the like, for example.

However, it is highly preferable to provide the wall portions 228 by bending both end sides, in the longitudinal direction, of the restricting plate 227 as in the foregoing second embodiment, because the wall portions 228 can be provided only through a plastic working such as bending, without having to perform any joining process such as welding, as described earlier.

Moreover, the foregoing first and second embodiments have described cases based on the rotary screen apparatuses 100 and 200 which perform screen printing of ink 1 onto the surface of a sheet. However, the liquid supply apparatus according to the present invention is not limited to these cases. For example, the liquid supply apparatus according to the present invention is applicable as described in the foregoing embodiments as long as the apparatus is a liquid supply apparatus which supplies liquid onto the surface of a target by extruding the liquid through holes in a plate with a squeegee, such as a rotary screen apparatus which performs screen printing of ink onto the surface of a web, a rotary screen apparatus which performs screen coating of varnish onto the surface of a sheet or web, as well as a lithographic screen apparatus which performs screen printing of ink and screen coating of varnish onto the surface of a sheet or web.

### INDUSTRIAL APPLICABILITY

Because the liquid supply apparatus according to the present invention is capable of evenly supplying liquid onto the surface of a target, the liquid supply apparatus according to the present invention can be utilized highly effectively in the printing industry and the like if applied to a rotary screen apparatus which performs printing of ink and/or coating of varnish onto the surface of a sheet or web from a rotary screen with a squeegee, for example.

### REFERENCE SIGNS LIST

1 INK
100 ROTARY SCREEN APPARATUS
110 IMPRESSION CYLINDER
120 ROTARY SCREEN
121 HOLLOW CYLINDER
121a SPACE
122 SUPPORT SHAFT
123 BRACKET
124 SQUEEGEE
125 FIXING PLATE
126 BOLT
127 RESTRICTING PLATE
129 INK DELIVERING PIPE
200 ROTARY SCREEN APPARATUS
220 ROTARY SCREEN
227 RESTRICTING PLATE
228 WALL PORTION

1. A liquid supply apparatus, comprising:
a plate having a plurality of holes formed therein and configured to come into contact, at one surface, with a surface of a target;
a squeegee configured to extrude liquid delivered to the other surface of the plate to the surface of the target through the holes by coming into contact with the other surface of the plate; and
liquid movement restricting means, disposed on a downstream side of the squeegee in a moving direction thereof in relative movement of the plate and the squeegee performed when the liquid is extruded through the holes in the plate, for restricting movement of the liquid such that the liquid is kept within a space present on a downstream side of a portion of the squeegee in contact with the plate in the moving direction.

2. The liquid supply apparatus according to claim 1, wherein the liquid movement restricting means covers at least a part of the space.

3. The liquid supply apparatus according to claim 1, wherein the liquid movement restricting means extends in such a way as to be connected to the squeegee with no gap therebetween.

4. The liquid supply apparatus according to claim 1, wherein the liquid movement restricting means is disposed in such a way as not to contact the plate, thus leaving a gap therebetween.

5. The liquid supply apparatus according to claim 1, wherein
the liquid movement restricting means includes:
a first liquid movement restricting member, disposed on the downstream side of the squeegee in the moving direction thereof in the relative movement of the plate and the squeegee performed when the liquid is extruded through the holes in the plate, for restricting movement of the liquid toward a downstream side in the moving direction such that the liquid is kept within the space present on the downstream side of the portion of the squeegee in contact with the plate in the moving direction; and
second liquid movement restricting members, disposed respectively on both end sides of the first liquid movement restricting member in a horizontal direction perpendicular to the moving direction, for restricting movement of the liquid in the horizontal direction perpendicular to the moving direction such that the liquid is kept within the space.

6. The liquid supply apparatus according to claim 5, wherein
the first liquid movement restricting member covers at least a part of a downstream side of the space in the moving direction, and
the second liquid movement restricting members cover at least a part of both end sides of the space in the horizontal direction.

7. The liquid supply apparatus according to claim 5, wherein the second liquid movement restricting members are formed by bending both end sides, in the horizontal direction perpendicular to the moving direction, of the first liquid movement restricting member toward the other surface of the plate.

8. The liquid supply apparatus according to claim 5, wherein the second liquid movement restricting members are disposed in such a way as not to contact the plate, thus leaving a gap therebetween.
